(19) United States
(12) Patent Application Publication
(10) Pub. No.: US 2022/0064069 A1
(43) Pub. Date: Mar. 3, 2022

(54) GYPSUM BUILDING MATERIAL WITH IMPROVED HIGH-TEMPERATURE RESISTANCE

(71) Applicant: Knauf Gips KG, Iphofen (DE)

(72) Inventors: Bernd PIETSCHMANN, Iphofen (DE); Michael STEINBAUER, Rottendorf (DE); Verena KOHLER, Scheinfeld (DE); Georgi PARASKOV, Neustadt an der Aisch (DE); Michael SCHNEIDER, Rodelsee (DE); Rauno BAESE, Würzburg (DE)

(21) Appl. No.: 17/415,405

(22) PCT Filed: Dec. 20, 2018
(86) PCT No.: PCT/EP2018/000574

§ 371 Date: Jun. 17, 2021

(51) Int. Cl. C04B 28/14; C04B 24/42; C04B 14/06; C04B 41/49; C04B 41/64

(52) U.S. Cl. CPC C04B 28/14; C04B 24/42; C04B 2111/34; C04B 41/4905; C04B 41/64; C04B 14/06

(57) ABSTRACT

A gypsum building material, characterised in that the gypsum building material comprises at least gypsum, H-siloxane and/or amorphous silicon dioxide and optionally further additives, wherein the H-siloxane is uniformly distributed in the gypsum building material and/or is applied to at least one surface of the gypsum building material, characterised in that the gypsum building material under the effect of temperatures of at least 80° C. has a longer expansion phase than a gypsum building material without H-siloxane and/or amorphous silicon dioxide, wherein the gypsum building material is otherwise of identical composition.

The invention relates to fire-resistant gypsum building materials and a method for producing gypsum building materials of this kind. In particular, the invention relates to gypsum boards which have an increased fire resistance rating.

Many gypsum building materials are known from the prior art. Due to the crystallisation water content of gypsum (CaSO₄·2 H₂O), gypsum building materials have advantageous properties in the case of fire. When gypsum is heated the crystallisation water is firstly expelled from the gypsum. Since this process is endothermic, the expulsion of the crystallisation water causes the gypsum building material to cool. With increasing water expulsion firstly calcium sulfate hemihydrate (CaSO₄·½ H₂O) forms, followed by the anhydrous phase anhydrite (CaSO₄). It is disadvantageous, however, that the transfer from gypsum to the calcium sulfate hemihydrate or anhydrite phases, which have a lower water content or are anhydrous, is associated with a reduction of the material volume. Additionally, the sintering of the material leads to a further loss of volume. This volume reduction causes the building material to shrink. Gypsum boards applied to a metal stud framework for example start to rupture from their attachments. Individual parts of a drywall construction may drop from the drywall construction, which constitutes a risk of injury for individuals located in the rooms. On the other hand, a breakdown of the building boards also means that a fire can break through to the rear side of a drywall construction and can spread into further rooms.

Measures are therefore known from the prior art which are intended to delay or prevent the breakdown of gypsum building materials under the effect of fire over a longer period of time. Fire-resistant filler materials such as clays or fire-expanding materials are often added. For example, it is known to introduce vermiculites into the gypsum material. The vermiculites can be expanded or raw, i.e. non-expanded. Raw vermiculites expand in the case of fire and are intended to at least partially compensate for the volume shrinkage.

The use of siloxanes for the waterproofing of gypsum products has long been known from the prior art and has been described many times.

These measures, however, on the whole are still not yet satisfactory, and therefore new solutions to this problem are sought.

The object of the invention lies in providing gypsum building materials which have an increased fire resistance and in particular at least significantly delay the time it takes for a fire to break through to the rear side of a drywall construction.

The object of the invention is solved by a gypsum building material according to claim 1 and a method for producing a gypsum building material according to claim 13.

A gypsum building material in the sense of this invention can be a gypsum product or a product that is made into a gypsum product by being processed. Gypsum building materials are used in the construction field. For example, they can be gypsum (building) boards, for example gypsum plasterboard or gypsum fibreboard, or also plasters, mortars or screeds based on calcium sulfate. A gypsum building material according to the invention therefore comprises at least gypsum, H-siloxane and/or amorphous silicon dioxide, in particular microsilica. Further additives known to a person skilled in the art may optionally be contained. The H-siloxane can be uniformly distributed in the gypsum building material and/or can be applied to at least one surface of the gypsum building material. The particular feature of the gypsum building material according to the invention lies in the fact that the gypsum building material under the effect of temperatures of at least 80° C. has a temporally longer expansion phase than a gypsum material without H-siloxane and/or amorphous silicon dioxide, but is otherwise of identical composition. The gypsum building material additionally has a lower temperature shrinkage than an identical gypsum building material without H-siloxane and/or amorphous silicon dioxide.

Within the scope of this invention the term “gypsum building materials” shall be understood to mean both pre-shaped bodies, for example gypsum building boards or partition wall boards and also bodies produced from materials such as plasters, fillers or screeds, the shaping of which is performed only by application to a surface.

The term “H-siloxane” preferably comprises linear, hydrogen-modified (organo)siloxanes. Although less preferred, cyclic hydrogen-modified siloxanes are not excluded. Such siloxanes can form heavily cross-linked silicone resins. The siloxanes, besides the H—Si bonds, preferably comprise organic groups, in particular alkyl groups, particularly preferably methyl groups. For example, an anhydrous polymethylhydrogensiloxane with trimethyl end groups (Silres BS 94) can be procured from Wacker-Chemie GmbH (Munich, Germany). Bluesil WR 68, an organosiloxane (methyl hydrogen polysiloxane) from the company Elkem, was used within the scope of the exemplary embodiments. Other siloxanes known to a person skilled in the art, however, can also be used

The term “amorphous silicon dioxide” within the scope of this invention shall comprise microsilica (silica fume) in particular. Microsilica is a fine powder (D50 in the nm to μm range), which for example accrues as by-product in the production of silicon or silicon alloys. Microsilica can be used as particulate matter or otherwise, for example in form of a suspension with a solvent, e.g. water. Microsilica can be procured for example from the company Elkem, in Oslo, Norway. Other amorphous silicon compounds are also suitable, for example fumed silica, which is produced pyrolytically.

The optionally provided further additives are known to a person skilled in the art as additives for gypsum building materials. These can be, for example, accelerators, retarders, liquefiers, thickeners, biocides, fungicides, or the like.

Both the use of H-siloxane and the use of amorphous silicon dioxide or a mixture of the two improves the fire resistance of gypsum building materials as compared to a gypsum building material that contains none of these materials, but is otherwise of identical composition. Within the scope of this invention the length in time of the expansion phase of the gypsum under defined temperature application and also the degree of shrinkage of the gypsum product during and after the temperature application are used as measures for the fire resistance of gypsum products.

These measurements were made according to and with an apparatus as described in WO 2017/000972 A1 the content of which is hereby incorporated into the application. As already mentioned further above, the dewatering of gypsum leads to the formation of phases with a lower water content and of smaller volume, specifically calcium sulfate hemihydrates or anhydrite. This is presumably the result of the expulsion of crystallisation water and of a sintering process in the material. This change in volume can be detected for example in that the length of a sample body is determined before and after a defined temperature treatment. After the temperature treatment the length of the sample body is shorter. Absolute values are of little significance in this context, since gypsums of different origin shrink to carrying degrees when subjected to the same temperature treatment. Only gypsums of identical origin and pre-treatment should therefore be directly compared with one another.

Before the actual shrinkage of the sample body under temperature application starts, however, the sample bodies first expand. Without wanting to be bound to a particular theory, it is assumed that this expansion is associated with the expulsion of the crystallisation water from the gypsum and conversion thereof into water vapour. The period of time of the expansion of the gypsum building material is referred to within the scope of this invention as the “expansion phase”. The expansion phase starts with the heating of the sample body and ends at the time at which the sample body has a shorter length than before the heating was started.

The difference between the length of the sample body before the application of temperature and the length of the sample body after a defined temperature application of 120 min., expressed in percent of original length (=length before temperature application), gives the “degree of shrinkage” of the sample body. The lower the degree of shrinking, the less the gypsum building material shrinks as a result of the temperature application.

Both the duration of the expansion phase and the degree of shrinking are dependent on the sample size and the sample shape. In case samples are taken from a board produced on a plasterboard line, also the orientation of the sample with respect to the production direction is relevant. Thus, only samples of approximately the same shape, size, weight, and if applicable the same sample orientation should be compared with one another.

The expansion phase of a gypsum building material according to the invention is preferably at least 1.2 times as long, preferably at least 2 times as long and particularly preferably at least 2.5 times as long as an expansion phase of a gypsum building material of identical composition without H-siloxane and/or amorphous silicon dioxide. During the expansion phase the gypsum building material remains stable. The expulsion of the crystallisation water is an endothermic process which consumes energy and therefore temporarily prevents or at least reduces the further heating of the gypsum building material. An extension of the expansion phase may extend the time that is available for example for the evacuation of a building.

In order to attain comparable results the sample bodies of the gypsum building materials according to the invention were subjected to a temperature application according to the temperature/time curve according to DIN EN 1363-1: 2012-10 for the first 60 minutes of the heating. On that basis the furnace temperature should satisfy the following ratio:

T=345 log10(8t+1)+20

wherein

T is the average furnace temperature in degrees Celsius and t is the time elapsed in minutes. During the first 60 min the samples are heated to approximately 950° C. After this initial period the temperature application according to the tests carried out deviated from DIN EN 1363-1: 2012-10: Between 60 and 120 min. test runtime, there a constant temperature application of 950° C. was used. Samples with a composition according to the invention have a smaller degree of shrinkage than specimens of identical composition but without H-siloxane and/or amorphous silicon dioxide.

The degree of shrinkage of a building material according to the invention is preferably at least 10% lower, preferably at least 50% and in particular at least 75% lower than the degree of shrinkage of a gypsum building material of identical composition but without H-siloxane or microsilica. As mentioned above the type of gypsum, wheight, size and orientation with respect to the production direction where applicable, have to be comparable.

In accordance with an embodiment of the invention the gypsum building material comprises between 0.01 and 10 wt.-% H-siloxane, in relation to the mass of used stucco. The gypsum building material preferably comprises at least 2 wt.-% H-siloxane in relation to the amount of used stucco. The upper limit for the use of H-siloxane is generally not critical but rather a consideration of cost. Since the influence on the shrinkage of the sample body with increasing H-siloxane contents, however, appears to approach a threshold value (corresponding to a minimal degree of shrinkage that cannot be further reduced by the proposed measures), and H-siloxane in addition is a relatively costly additive, it is advantageous to use no more than 5 wt.-% H-siloxane in relation to the amount of used stucco. In order to attain an optimal cost:use ratio, a range of from 3 to 4.5 wt.-% H-siloxane in relation to the amount of used stucco is proposed for the H-siloxane distributed uniformly in the gypsum building material, if microsilica is not added in addition. If a combination of H-siloxane with amorphous silicon dioxide is used, the content of H-siloxane can advantageously be significantly reduced, depending on the amount of added amorphous silicon dioxide. If the H-siloxane is used as coating on at least one surface of the gypsum building material, the applied amounts can be much lower. Good shrinkage values are already achieved with coatings containing approximately 75 g H-siloxane per m² coated surface (corresponds to approximately 0.2 wt.-% in relation to the dihydrate content of a board 12 mm thick). Twice the amount, that is to say approximately 150 g/m² results in a sudden increase in the effect. Optimal results are achieved if the majority of the surfaces of a gypsum building material are coated with H-siloxane.

In accordance with another embodiment of the invention the gypsum building material can contain at least 0.5 wt.-% amorphous silicon dioxide, in particular microsilica, in relation to the amount of used stucco. The amorphous silicon dioxide can be contained in the gypsum building material instead of H-siloxane or additionally to H-siloxane. No more than 20 wt.-% amorphous silicon dioxide, however, should be used at most. Lower amounts, such as at most 10 wt.-% or at most 6 wt.-% amorphous silicon dioxide are preferably used. The actual amount of the used amorphous silicon dioxide is dependent inter alia on whether H-siloxane is additionally also comprised. In this case, lower amounts of amorphous silicon dioxide are sufficient.

The content of H-siloxane is preferably lower than the content of amorphous silicon dioxide. In accordance with a particularly preferred embodiment of the invention the gypsum building material for example can comprise a combination of from 1 to 2.5 wt.-% H-siloxane and from 1 to 5 wt.-% amorphous silicon dioxide.

In accordance with a particularly preferred embodiment of the invention the gypsum building material is a gypsum building board. The fire resistance of a gypsum building board is increased effectively if at least one large surface of the gypsum building board is coated, painted, sprayed or otherwise treated with H-siloxane. In particular, the upper side or visible side of a gypsum building board should be treated with H-siloxane because this side is typically the side that will be directly exposed to a potential fire. The treatment of both large surfaces of a gypsum building board, specifically both the upper side and the lower side is even more effective.

A method according to the invention for producing a gypsum building board comprises the production of at least one slurry by mixing at least (stucco) and water with one another. This slurry is then shaped into an endless strand of gypsum building board, which, once the gypsum has set sufficiently, is separated into individual gypsum building boards. In addition to stucco and water, H-siloxane and/or amorphous silicon dioxide, in particular microsilica, can be added for production of the slurry. Alternatively or additionally, H-siloxane can be applied to at least one surface of the endless strand of gypsum building board or the separated individual gypsum building boards. The gypsum building boards equipped with H-siloxane and/or amorphous silicon dioxide under the effect of temperatures of at least 80° C. have a longer expansion phase than gypsum building boards without H-siloxane and/or amorphous silicon dioxide, wherein the gypsum building board is otherwise of identical composition.

According to another embodiment of the invention at least one first and one second slurry can be produced, wherein at least the first slurry contains H-siloxane and/or amorphous silicon dioxide, and wherein the first slurry is used to form at least one edge layer of the gypsum building board. An edge layer, that is to say the layer that is in direct contact with the liner, is in particular advantageous in the case of lightweight gypsum building boards. It is typically denser than the core layers arranged further inward. Due to the higher density, it increases the contact area between liner and board core, whereby the liner is better bonded to the core. In addition, the edge layer significantly increases the mechanical properties without making the board much heavier. The introduction of H-siloxane and/or amorphous silicon dioxide affords the edge layer, which is known per se, with yet a further advantage: it increases the fire resistance of the board. It is likewise advantageous that the additive, i.e. H-siloxane and/or amorphous silicon dioxide, is required merely in a comparatively small amount, because only the thin edge layers (<7 mm thick) have to be provided with it, rather than the entire board core.

Protection is also sought for the use of H-siloxane and/or amorphous silicon dioxide in order to reduce the degree of shrinkage of a gypsum building material under the effect of high temperature. The gypsum building materials in which these substances are used, when heated in accordance with the temperature/time curve according to DIN EN 1363-1: 2012-10 for the first 60 min and kept at 950° C. afterwards as described above, have a lower degree of shrinkage and/or an extended expansion time compared to the degree of shrinkage and or expansion time of a gypsum building material without H-siloxane and/or amorphous silicon dioxide with otherwise identical composition. In the test, samples of the gypsum building material are heated from 0 to 60 min to 950° C. and kept constantly at 950° C. from 60 to 120 min. The invention will be explained in greater detail hereinafter on the basis of specific exemplary embodiments, in which:

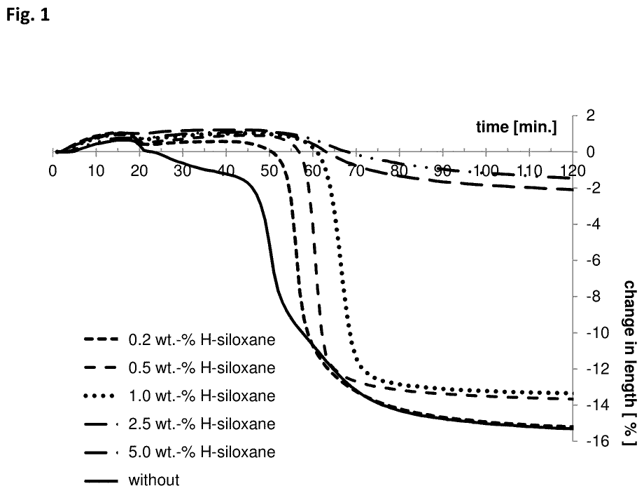

FIG. 1: shows the change in length of prisms with different H-siloxane contents whilst subjected to a temperature treatment.

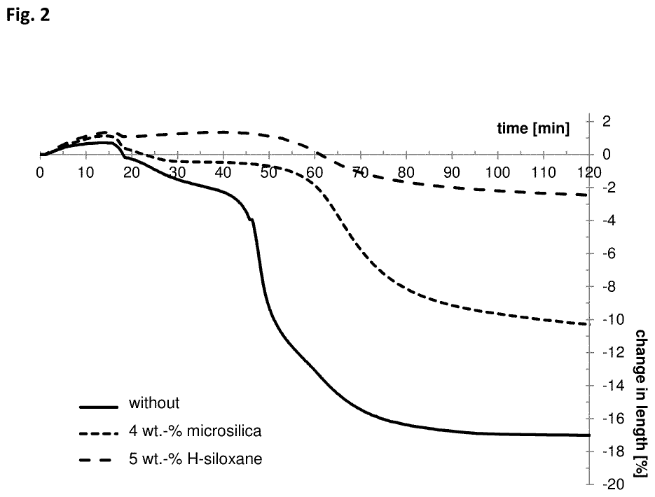

FIG. 2: shows the change in length of prisms which contain H-siloxane or microsilica whilst subjected to a temperature.

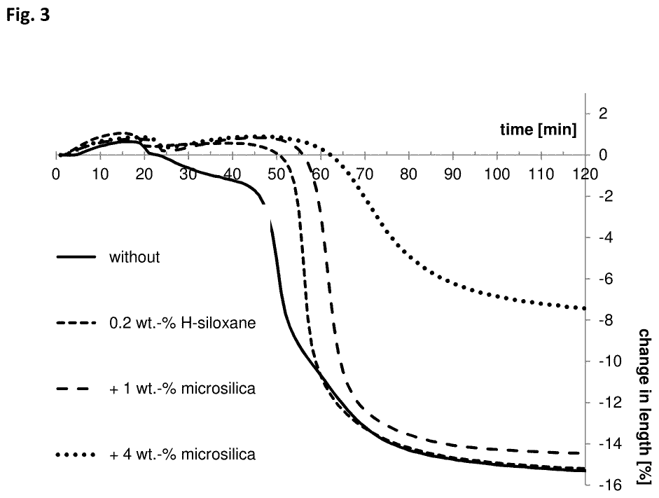

FIG. 3: shows the change in length of prisms with 0.2 wt.-% H-siloxanes and different amounts of microsilica whilst subjected to a temperature treatment.

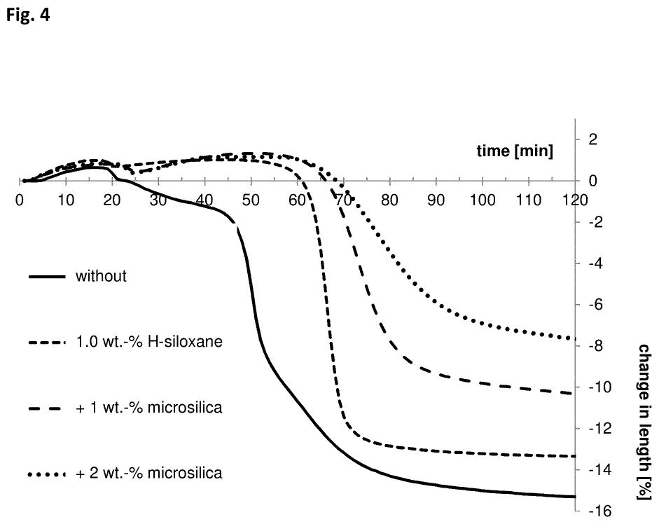

FIG. 4: shows the change in length of prisms with 1.0% wt.-% H-siloxanes whilst subjected to a temperature treatment.

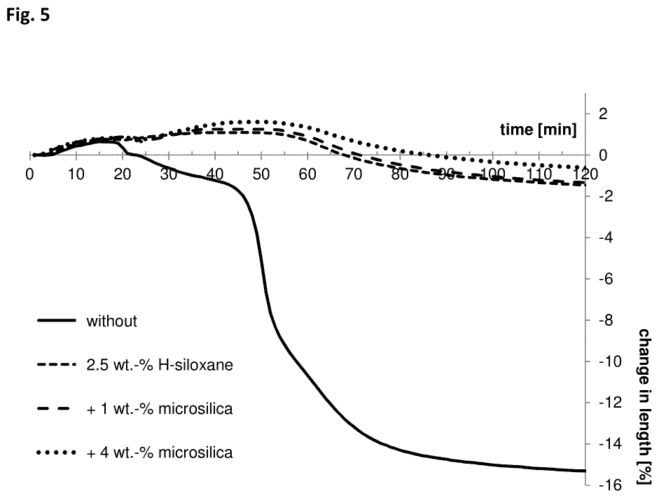

FIG. 5: shows the change in length of prisms with 2.5 wt.-% H-siloxanes and different amounts of microsilica whilst subjected to a temperature treatment.

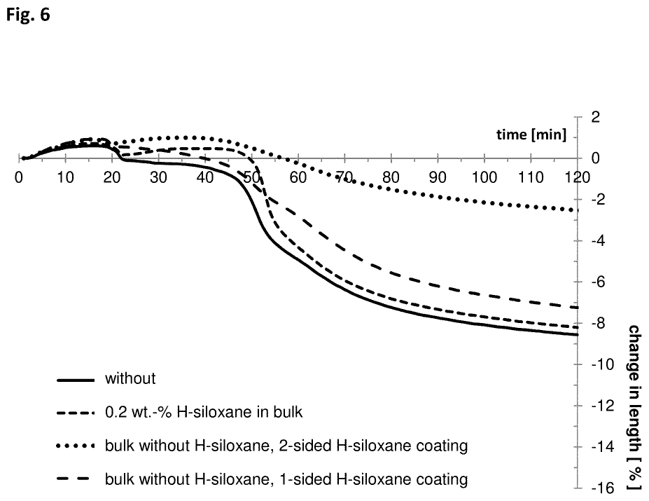

FIG. 6: shows the change in length of prisms with 0.2 wt.-% H-siloxane and prisms treated merely at their surface with H-siloxane, whilst subjected to a temperature treatment.

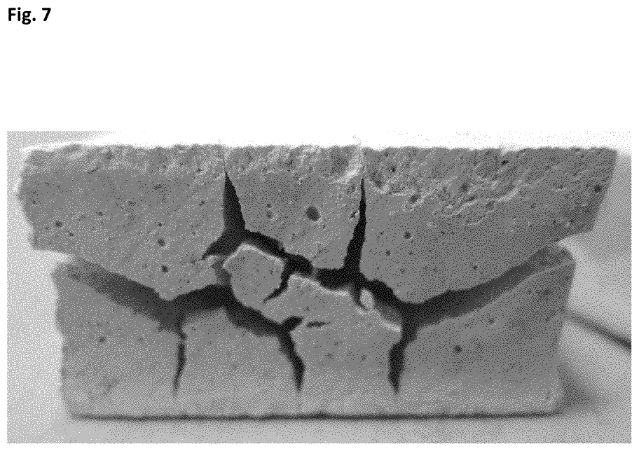

FIG. 7: shows a photo of a prism with H-siloxane coating on both sides after the temperature application.

The examined prisms (test specimen) were produced as follows: stucco and an accelerator were pre-mixed to form a dry mix. The samples for which the change in length is shown in FIGS. 1 to 5 were produced using a stucco obtained from 70 wt.-% FGD (flue gaz desulfurization) gypsum and 30 wt.-% natural gypsum. The prisms for which the change in length is shown in FIG. 6 were produced from a stucco which was obtained substantially from natural gypsum with 7 wt.-% FGD gypsum. The dry mix was scattered into water, the amount of which corresponded to a water-gypsum value of 0.6, and was mixed after a short soaking time using a whisk. The slurry thus produced was used to cast prisms measuring 16×4×2 cm³, which were demoulded 25 min after the mixing. The prisms thus produced were dried in a drying cabinet at 40° C. to a constant weight. The prisms were then sawn to size (10×4×2 cm³).

If the prisms contained H-siloxane (BlueSil WR 68 from Bluestar Silicones, now Elkem) or microsilica (Elkem 940U), these substances were either added to the slurry or, in the case of a siloxane coating, were applied to the prisms using a brush.

The change in length under temperature application was brought about in a quickly heating chamber furnace. The chamber furnace was heated heavily for the first 60 min. in accordance with the temperature/time curve according to DIN EN 1363-1: 2012-10. Thereafter, the furnace temperature was held constant for a further 60 min. at 950° C. The prisms were placed on roller holders which did not put up any resistance to the change in length of the prism. One narrow side of the prism was arranged on an abutment face, and a spring arm with distance recorder exerted a force against the opposite narrow side, which force fixes the prism against the abutment. The distance recorder continuously recorded the length of the prism. The change in length of the prism was obtained by subtracting the length of the prism at certain moments in time (substantially continuously measured) during the temperature application from the length of the prism prior to the temperature application.

FIG. 1 shows the change in length of gypsum prisms with different contents of H-siloxane mixed into the slurry. The solid curve shows a reference sample, containing no H-siloxane. The reference sample prism expands moderately during the first approximately 20 min. It is assumed that in this phase of expansion the crystallisation water is driven out from the gypsum crystals, but can escape only slowly from the prims. The result is an increase in the volume of the prism. This period of time was recorded within the scope of this invention as expansion phase. Between 20 and 45 min. there is a moderate shrinkage of the prism. In the period of time between 45 and 59 min. there is then an abrupt reduction in volume. Without wanting to be bound to this theory, it is assumed that in this period the material sinters. The sintering process continues in slightly weakened form up to approximately 70 min. Afterwards, the prism length decreases continuously, but only to a very small degree.

Considering the change in length to the prisms that contain different H-siloxane concentrations, it can be determined that the phase of the expansion in all samples with H-siloxane is significantly extended. Depending on the concentration of the H-siloxane, the expansion phase lasts from 50 (0.2 wt.-% H-siloxane) up to 75 min. (5 wt.-% H-siloxane) and extends with increasing H-siloxane content. The prisms contained between 0.2 and 1 wt.-% H-siloxane then transition seamlessly into the sintering process, which leads to a drastic decrease in the length of the prisms. Interestingly, the prisms that contain H-siloxane in higher concentrations do not appear to experience any sintering process, or only appear to experience a sintering process to a small degree. Anyhow, these prisms show no significant shrinkage within the space of just a few minutes as the other prisms do. A shrinkage lasting a long period of time was observed and appeared to approach a threshold value. The effect of the different H-siloxane concentrations on the degree of shrinkage at the end of the temperature application is also interesting. Low H-siloxane concentrations of up to approximately 1% by weight in relation to the used stucco appear to have only a very small influence on the overall shrinkage. Compared to the reference sample, the degree of shrinkage of which is more than 15%, the prisms with up to 1 wt.-% H-siloxane are only slightly better. Their degree of shrinkage lies between 13 and 14%.

The influence on the degree of shrinkage appears to rise suddenly when a H-siloxane content of between 1 wt.-% and 2.5 wt.-% was used. In any case the prisms with 2.5 and 5 wt.-% H-siloxane present a degree of shrinkage of only 1 to 2%. It is supposed that there is a threshold value or a limit range from which H-siloxane effectively influences the degree of shrinkage. In the samples shown here this limit lies between 1 and 2.5 wt.-% H-siloxane. It must be assumed, however, that the actual threshold value for each gypsum type is slightly different on account of different impurities.

It seems that the degree of shrinkage hardly improves if the concentration of H-siloxane increases further still (to 5 wt. % or more).

The phase of the significant reduction in volume of the prisms, characterised in these tests by the significant change in length, is supposedly triggered by a sintering process of the sample material. The significant reduction in volume is very dangerous for example in the case of drywalls exposed to a fire, because parts of the boards can detach from their supports and fall into rooms. The dropping board parts can directly injure people or can indirectly block escape routes. In addition, the parts absent from the drywalls mean that the fire can spread to adjacent rooms. Fire protection in the case of a drywall on the one hand thus aims to suppress the volume reduction of the gypsum material to the greatest possible extent. On the other hand, should a volume reduction nevertheless occur, this should be as late as possible and as small as possible.

The test prisms shown in FIG. 1 show that even small amounts of H-siloxane in the sample material cause the expansion phase of the prisms to be extended significantly. Even 0.2 wt.-% H-siloxane extend this period by 2.5 times. If it turns out that these test results translate well into actual drywall constructions, the following could be deduced: In the event of a fire this would mean that drywalls retained their integrity for at least twice as long because they would not shrink in the same way as drywalls not containing any H-siloxane. Thus, twice the amount of time would be available for rescue measures and for escape, which could save human lives. If boards with higher H-siloxane contents are used, the shrinkage could be almost completely prevented.

A similar effect appears to be provided by the addition of amorphous silicon dioxide, or what is known as microsilica in the case of the results shown in FIG. 2. The actual expansion phase of the prism with 4 wt.-% microsilica indeed appears to be only insignificantly longer than that of the reference sample. The subsequent shortening of the prism between 20 and 60 min., at less than 1% shortening, is very low however compared to the original length of the prisms. The decrease in length during the sintering is relatively moderate. However, the prism after the temperature application is approximately 10% shorter than the untreated sample. By comparison, the addition of 5 wt.-% H-siloxane leads to a degree of shrinkage of barely 2%.

FIGS. 3 to 5 show the shrinkage of prisms over time that contain different amounts of a combination of H-siloxane and microsilica. The prisms in FIG. 3 all contain 0.2 wt.-% H-siloxane, apart from the reference sample, which contains neither H-siloxane nor microsilica. The addition of 1 wt.-% microsilica extends the expansion phase of the prism, compared to the prism containing only 0.2 wt.-% H-siloxane, by approximately 5 min. and reduces the degree of shrinkage slightly. If, however, 4 wt.-% microsilica are added, the expansion phase extends by 10 min. and the degree of shrinkage is halved. The combination of the effects of small amounts of H-siloxane with larger amounts of microsilica appears to reduce the degree of shrinkage overporportionally compared to the effect resulting from an addition of the effects of the prisms with 0.2 wt.-% H-siloxane (FIG. 3) on the one hand and 4 wt. % microsilica (FIG. 2) on the other hand.

Approximately the same reduction of the degree of shrinkage can be achieved with a combination of 1 wt.-% H-siloxane and 2 wt.-% microsilica (see FIG. 4). The higher content of H-siloxane, however, generally leads to an extension of the expansion phase.

FIG. 5 shows that the shrinkage of the gypsum prisms under temperature application can be almost completely eliminated (<1.5%) if 2.5 wt.-% H-siloxane are combined with 1 wt.-% microsilica. If 4 wt.-% microsilica are added, the degree of shrinkage even lies only at approximately 0.5%.

It is clear from FIG. 6 that both the expansion phase and the degree of shrinkage likewise can be significantly improved if one or both large surfaces of the prism are coated with H-siloxane. The gypsum used here consists substantially of natural gypsum (see above), which without further additives shrinks by more than 8%. For reference, a prism with 0.2 wt.-% H-siloxane in the slurry was produced. The course of the curve corresponds approximately to the course described in relation to FIG. 1.

A prism produced from stucco, water and accelerator was coated with H-siloxane after the drying in the drying cabinet. The amount of H-siloxane corresponded to approximately 0.2 wt.-% in relation to the amount of dihydrate in the prism. A further prism was coated on both sides with H-siloxane. The applied amount corresponded to approximately 1.1 wt.-% in relation to the amount of dihydrate in the prism.

Even one-sided coating with a relatively small amount of H-siloxane leads to a slight extension of the expansion phase. The prism coated on both sides, however, has a sudden improvement both of the duration of the expansion phase and the degree of shrinkage. It has been found that the coating of gypsum building materials with H-siloxane is also an adequate way of improving the fire resistance.

FIG. 7 shows a photo of its prism which has been coated on both sides with H-siloxane and subjected to the temperature application as described above. The shrinkage of the material in the board core can be clearly seen on the basis of the strong crack formation. The gaps that open up into the cracks, however, become increasingly smaller and disappear completely in the direction of the coated surfaces (at the top and bottom). It can be seen under microscope that the edge regions of the prism have only small and short cracks, and therefore the cohesion of the surface is maintained in spite of the apparently high material loss in the core.

1. A gypsum building material comprising at least gypsum, an H-siloxane and/or an amorphous silicon dioxide, wherein the H-siloxane is uniformly distributed in the gypsum building material and/or is applied to at least one surface of the gypsum building material, wherein the gypsum building material under an effect of temperatures of at least 80° C. has a longer expansion phase than another gypsum building material without the H-siloxane and/or the amorphous silicon dioxide, wherein the other gypsum building material is otherwise of an identical composition.

2. The gypsum building material according to claim 1, wherein the expansion phase of the gypsum building material is at least 1.2 times a time of the expansion phase of the other gypsum building material of the identical composition but without the H-siloxane or the amorphous silicon dioxide.

3. The gypsum building material according to claim 1, wherein the gypsum building material under the effect of temperature in accordance with a temperature/time curve according to DIN EN 1363-1: 2012-10 for a first 60 min. and under constantly 950° C. during a next 60 min. has a smaller degree of shrinkage than the other gypsum building material of the identical composition, but without the H-siloxane and/or the amorphous silicon dioxide.

4. The gypsum building material according to claim 3, wherein a degree of shrinkage of the gypsum building material is at least 10% lower than the degree of shrinkage of the other gypsum building material of the identical composition, but without the H-siloxane and/or the amorphous silicon dioxide.

5-6. (canceled)

7. The gypsum building material according to claim 6, wherein the gypsum building material comprises 1 to 2.5 wt.-% of the H-siloxane and 1 to 5 wt.-% of the amorphous silicon dioxide.

8. The gypsum building material according claim 1, wherein the amorphous silicon dioxide comprises microsilica and/or pyrolytically produced silicon dioxide.

9. The gypsum building material according to claim 1, wherein the gypsum building material is a gypsum building board.

10. The gypsum building material according to claim 1, wherein at least one surface of the gypsum building board is treated with the H-siloxane.

11. The gypsum building material according to claim 10, wherein at least two surfaces, preferably an upper side and an underside, of the gypsum building board are treated with the H-siloxane.

12. The gypsum building material according to claim 9, wherein the gypsum building board has at least one first edge layer and a core layer, wherein at least the first edge layer contains the H-siloxane and/or the amorphous silicon dioxide.

13. A method for producing a gypsum building board, wherein at least one slurry is produced in that at least stucco and water are mixed with one another, the slurry is formed into an endless strand of gypsum building board, which is then separated into the gypsum building boards and the gypsum building boards are dried, the method comprising producing the slurry, wherein H-siloxane and/or amorphous silicon dioxide are/is additionally used, and/or applying H-siloxane is applied to at least one surface of the endless strand of the gypsum building board or of the separated gypsum building boards, such that the gypsum building board under an effect of temperature of at least 80° C. has a longer expansion phase than another gypsum building board without the H-siloxane and/or the amorphous silicon dioxide, wherein the other gypsum building board is otherwise of an identical composition.

14. The method according to claim 13, wherein at least one first and one second slurry are produced, and the first slurry contains the H-siloxane and/or the amorphous silicon dioxide, and wherein the first slurry is used to form at least one edge layer of the gypsum building board.

15. A method to reduce the degree of shrinkage of a gypsum building material under an effect of temperature, the method comprising the step of adding an H-siloxane and/or an amorphous silicon dioxide to said gypsum building material, wherein the gypsum building material in accordance with a temperature/time curve according to DIN EN 1363-1: 2012-10 is heated from 0 to 60 min to 950° C. and is treated from 60 to 120 min with a constant temperature application of 950° C., and wherein the gypsum building material has a longer expansion phase and/or a smaller degree of shrinkage as compared to another gypsum building material without the H-siloxane and/or the amorphous silicon dioxide but of otherwise identical composition.

16. The gypsum building material according to claim 1, wherein the gypsum building material comprises further additives.

17. The gypsum building material according to claim 2, wherein the expansion phase of the gypsum building material is at least 2 times the time of the expansion phase of the gypsum building material of the identical composition but without the H-siloxane or the amorphous silicon dioxide.

18. The gypsum building material according to claim 17, wherein the expansion phase of the gypsum building material is at least 2.5 times the time of the expansion phase of the gypsum building material of the identical composition but without the H-siloxane or the amorphous silicon dioxide.

19. The gypsum building material according to claim 4, wherein the degree of the shrinkage of the gypsum building material is at least 50% lower than the degree of the shrinkage of the other gypsum building material of the identical composition, but without the H-siloxane and/or the amorphous silicon dioxide.

20. The gypsum building material according to claim 19, wherein the degree of the shrinkage of the gypsum building material is at least 75% lower than the degree of the shrinkage of the other gypsum building material of the identical composition, but without the H-siloxane and/or the amorphous silicon dioxide.

21. The gypsum building material according to claim 1, wherein the gypsum building material is produced from at least one slurry which is produced in that at least stucco and water are mixed with one another, wherein the gypsum building material comprises between 0.01 and 10 wt.-% of the H-siloxane, in relation to a mass of the used stucco.

22. The gypsum building material according to claim 1, wherein the gypsum building material is produced from at least one slurry which is produced in that at least stucco and water are mixed with one another, wherein the gypsum building material comprises at least 0.5 wt.-% in relation to an amount of the used stucco, and at most 20 wt.-% in relation to the amount of the used stucco of the amorphous silicon dioxide.
